(19) United States
(12) Patent Application Publication
(10) Pub. No.: US 2026/0167196 A1
(43) Pub. Date: Jun. 18, 2026

(54) INTERACTIVE LANE CHANGE CONTROL SYSTEM, METHOD AND DISPLAY INTERFACE

(71) Applicant: Industrial Technology Research Institute, Hsinchu (TW)

(72) Inventors: Kun-Lung Ku, Changhua County (TW); Chia-Jui Hu, New Taipei City (TW); Hsiu-Wei Hsu, Hsinchu County (TW)

(73) Assignee: Industrial Technology Research Institute, Hsinchu (TW)

(21) Appl. No.: 18/983,369

(22) Filed: Dec. 17, 2024

(51) Int. Cl. B60W 30/18; G08G 1/16

(52) U.S. Cl. CPC B60W 30/18163; G08G 1/166; B60W 2552/10; B60W 2554/4041; B60W 2554/4049

(57) ABSTRACT

In the disclosure, via an interactive lane change control system and method, by pre-laterally offsetting the vehicle, the driver may interact with the neighboring vehicle when changing lanes, thereby obtaining the willingness of the neighboring vehicle to give way, and may change lanes safely when actually changing lanes. In addition, via the display interface, the road conditions and the status of each vehicle may be presented to the driver in a visual manner, allowing the driver to better control the driving status thereof and increase driving safety.

### TECHNICAL FIELD

The disclosure relates to a lane change control system, method, and display interface, and more particularly to an interactive lane change control system, method, and display interface.

### BACKGROUND

With the development of autonomous driving techniques, lane change assist control systems have become one of the key techniques to improve driving safety and comfort. Improving driving safety may reduce the risk of accidents caused by lane changes. Currently, new models of many vehicle manufacturers are equipped with lane centering and adaptive cruise control systems that may assist driving for a long time. If combined with a lane change assist control system, the driver may automatically change lanes via the system without the need to cancel the assisted driving mode when encountering a slow vehicle ahead or needing to drive according to the navigation route, without the need for manual operation. However, when the current lane change assist system is activated, if the target lane is currently unsafe, the system may not select a suitable entry point according to the traffic dynamics and instead follows the vehicle conditions in the current lane. Furthermore, current autonomous driving techniques are unable to make exploratory moves to interact with the vehicle behind in order to find the right time to enter the target lane.

Therefore, how to increase the interaction between the vehicle and other vehicles to change lanes more appropriately when running autonomous driving is an important issue.

### SUMMARY

Accordingly, the disclosure provides an interactive lane change control system, method, and display interface to test the willingness of vehicles in adjacent lanes to give way as a reference for changing lanes, and further change lanes safely.

An interactive lane change control system of the disclosure includes a storage device and a processor. The storage stores a plurality of modules. The processor is coupled to the storage and configured to: execute a dynamic select lane change gap module in a plurality of modules to select a first lane gap in a first target lane; and determine a first path of a vehicle according to a feedback parameter of a first neighboring vehicle.

An interactive lane change control method of the disclosure includes: executing a dynamic select lane change gap module in a plurality of modules to select a first lane gap in a first target lane; and determining a first path of a vehicle according to a feedback parameter of a first neighboring vehicle.

A display interface of interactive lane change control of the disclosure displays a plurality of first lane gaps in a first target lane; and displays each feedback parameter of each first neighboring vehicle in the plurality of first lane gaps.

### BRIEF DESCRIPTION OF THE DRAWINGS

FIG. 1 is a schematic diagram of an interactive lane change control system of the disclosure.

FIG. 2 is a schematic diagram of the operation flow of an interactive lane change control system of the disclosure.

FIG. 3 is a detailed block diagram of the operation flow of an interactive lane change control system of the disclosure.

FIG. 4 is a schematic diagram of lane change of the disclosure.

FIG. 5 is a detailed block diagram of pre-lateral offset lane change of the disclosure.

FIG. 6 is a schematic diagram of pre-lateral offset lane change of the disclosure.

FIG. 7 is a schematic diagram of dynamic select lane change gap of the disclosure.

FIG. 8A is a block diagram of dynamic select lane change gap of the disclosure.

FIG. 8B is a detailed block diagram of dynamic select lane change gap of the disclosure.

FIG. 9 is a display flowchart of a display interface of interactive lane change control of the disclosure.

### DESCRIPTION OF THE EMBODIMENTS

Reference will now be made in detail to exemplary embodiments of the disclosure, examples of which are illustrated in the accompanying drawings. Terms such as “first” and “second” mentioned throughout the specification (including the claims) of the present application are used to name elements or to distinguish between different embodiments or scopes, and are not used to limit the upper bound or the lower bound of the number of elements, nor used to limit the sequence of elements. In addition, wherever possible, elements/members adopting the same reference numerals in the drawings and embodiments denote the same or similar parts.

In each embodiment of the disclosure, the direction in which the vehicle is traveling straight is defined as the positive direction of the first direction, and the direction from the lane in which the vehicle is traveling to the target lane to which the vehicle is to change is defined as the positive direction of the second direction. Moreover, the first neighboring vehicle is defined as the vehicle in the negative direction of the first direction in the target lane.

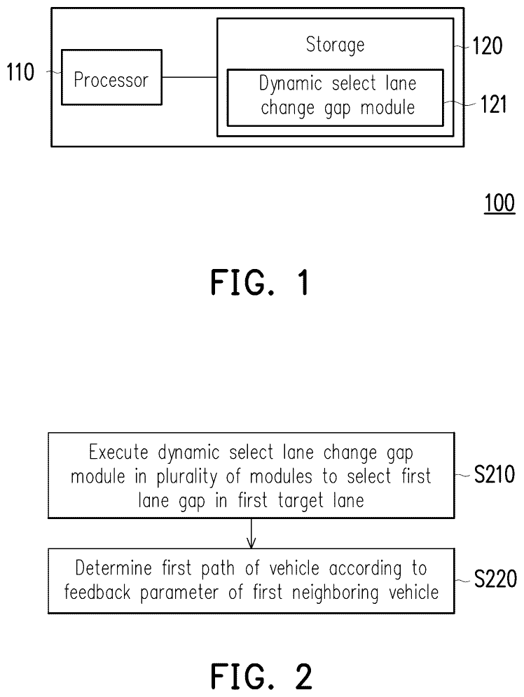

FIG. 1 is a schematic diagram of an interactive lane change control system provided by the disclosure. An interactive lane change control system 100 may include a processor 110 and a storage 120.

In an embodiment of the disclosure, the processor is, for example, a central processing unit (CPU), or other programmable general-purpose or special-purpose micro control unit (MCU), microprocessor, digital signal processor (DSP), programmable controller, application-specific integrated circuit (ASIC), graphics processing unit (GPU), image signal processor (ISP), image processing unit (IPU), arithmetic logic unit (ALU), complex programmable logic device (CPLD), field-programmable gate array (FPGA), or other similar elements, or a combination of the above elements. In the interactive lane change control system 100, the processor 110 may be coupled to the storage 120, and the processor 110 may execute each module stored in the storage 120.

The storage 120 is, for example, any type of fixed or removable random-access memory (RAM), read-only memory (ROM), flash memory, hard-disk drive (HDD), solid-state drive (SSD), or similar elements, or a combination of the above elements, and is used to store a plurality of modules or various applications that may be executed by the processor 110. In the present embodiment, the storage 120 may store at least a dynamic select lane change gap module 121.

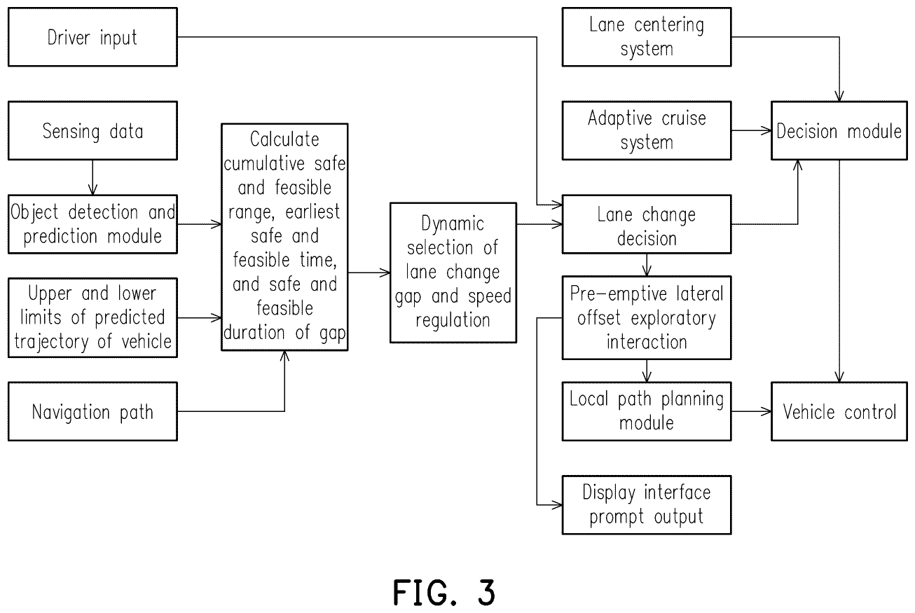

Please refer to FIG. 2. FIG. 2 is a schematic diagram of the operation flow of an interactive lane change control system of the disclosure that may be implemented by the processor 110. In process S210, the processor 110 may execute a dynamic select lane change gap module in a plurality of modules to select a first lane gap in a first target lane. In process S220, the processor 110 may determine a first path of a vehicle according to a feedback parameter of a first neighboring vehicle.

Specifically, when the vehicle is traveling straight in the lane the vehicle is traveling in, and the owner wants to change the vehicle to the adjacent first target lane, if the distance of the first neighboring vehicle in the negative direction relative to the first direction of the vehicle in the first target lane is less than the value of a safety distance, the processor 110 may execute a pre-lateral offset exploratory interaction module in the plurality of modules stored in the storage 120 to pre-laterally offset the vehicle and test the feedback parameter from the first neighboring vehicle in the first target lane to be changed to as a basis for the processor 110 to decide whether the vehicle should change lanes or stay in the original lane. The value is, for example, 40 meters. The definition of the value of the disclosure may be determined according to the speed and the tonnage of the vehicle and the speed and the tonnage of the first neighboring vehicle. The feedback parameter is, for example, the speed reduction of the first neighboring vehicle. The disclosure will further describe the feedback parameter in subsequent paragraphs.

It should be understood that if the value is greater than the safety distance, the vehicle does not need to test the feedback parameter of the first neighboring vehicle, and the vehicle may directly change to the target lane.

Continuing from the previous paragraph, when the processor 110 determines that the feedback parameter of the first neighboring vehicle is greater than the first lane-change threshold, for example, the first neighboring vehicle is willing to yield and the first neighboring vehicle slows down to four-fifths of the original speed thereof, at this time, the distance (the first lane gap) between the first neighboring vehicle and the vehicle in the positive direction of the first direction (the vehicle ahead) is increased without reducing the speed of the vehicle ahead, and the vehicle may then change to the first lane gap. When the processor 110 determines that the feedback parameter of the first neighboring vehicle is not greater than the first lane change threshold, for example, if the first neighboring vehicle has no intention to yield and the first neighboring vehicle continues to maintain the original speed thereof, or even the first neighboring vehicle slightly increases the speed thereof, the processor 110 may control the vehicle to remain in the driving lane, and the processor 110 may control the vehicle to drive on the center line of the second lane.

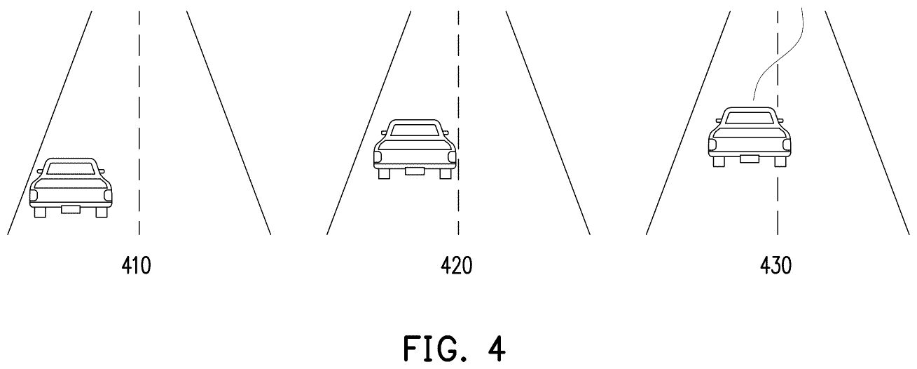

Please refer to FIG. 3. FIG. 3 is a detailed block diagram of the operation process of an interactive lane change control system of the disclosure, further describing the exploratory lane change decision. First, the driver may input lane change information to make lane change decisions, that is, the driver may instruct the vehicle to change lanes according to their own preferences or ideas. In addition, the interactive lane change control system 100 may also make lane change decisions according to different scenarios. In an embodiment of the disclosure, the processor 110 may execute the object detection and prediction module to obtain the sensing data of a plurality of body information of a plurality of first neighboring vehicles in the lane to be changed sensed by the processor 110. Due to the different lengths and weights of different vehicles, the reaction time needed for different vehicles when encountering the same emergency situation is not the same. It is known to those skilled in the art that the heavier the vehicle, the longer the reaction time.

Continuing from the above, the interactive lane change control system 100 may also determine whether to change lanes according to the navigation path. The interactive lane change control system 100 may also predict the upper and lower limits of the moving trajectory of the vehicle according to the object of the vehicle. In an embodiment of the disclosure, the moving trajectory takes the future position of the leading vehicle followed by the adaptive cruise control (ACC) as the upper limit, and the trajectory generated by decelerating to the minimum speed value at the set comfortable deceleration as the lower limit. In particular, the set minimum speed is related to the traffic speed in the target lane and the speed of the vehicle ahead in the current lane. For example, if the traffic speed in the target lane is 60 km/h, the minimum speed should not be lower than 60 km/h to avoid being unable to change lanes.

Continuing from the previous paragraph, in other embodiments of the disclosure, a safe and feasible range also needs to be considered when changing lanes. Therefore, in addition to the upper and lower limits of the movement trajectory of the vehicle, when a vehicle is about to go from the inner lane to the outer lane of the highway to leave the interchange, the vehicle needs to change to the outer lane at a first specific distance from the interchange before the vehicle may safely exit the interchange. This first specific distance is the upper limit of the moving trajectory. Alternatively, if the vehicle enters the inner lane in order to travel faster, the vehicle should not switch to the outer lane before the second specific distance from the interchange to avoid driving too slowly. The second specific distance is the lower limit of the moving trajectory.

Continuing from the previous paragraph, the processor 110 may calculate the cumulative safe and feasible range, the earliest safe and feasible time, and the safe and feasible duration of the plurality of first lane gaps according to the sensing data, the navigation path, and the upper and lower limits of the moving trajectory of the vehicle, and the processor 110 may accordingly dynamically select the first lane gap as the target lane gap for changing the vehicle and adjust the vehicle speed. For example, when the processor 110 determines that the accumulated safe and feasible range of the first first lane gap is not enough for the vehicle to change lanes safely, the processor 110 may reduce the speed of the vehicle to enter the second first lane gap range to prepare for lane change.

Please continue to refer to FIG. 3. When the processor 110 receives the lane change instruction input by the driver, or the processor 110 determines according to information such as the vehicle, other vehicles, and navigation paths, when the processor 110 issues a lane change decision to the vehicle, the processor 110 may directly execute the decision module to control the vehicle and change lanes. Moreover, the processor 110 may also perform pre-lateral offset exploratory interaction on the vehicle to test the feedback parameters of the neighboring vehicle in the target lane to be changed, as a basis for the willingness of the neighboring vehicle to change lanes, thereby increasing safety when changing lanes. When the processor 110 performs pre-lateral offset exploratory interaction, the processor 110 may execute a local path planning module to plan a moving path of the vehicle within a certain distance range in the current driving lane. The certain distance range is, for example, a driving distance within 200 meters. The implementer of the disclosure may adjust the distance length of the certain distance range according to actual applications.

In an embodiment of the disclosure, when the processor 110 performs pre-lateral offset exploratory interaction, the processor 110 may display the relevant information of the vehicle during pre-lateral offset via the display interface, so as to provide the driver with the information of the current vehicle. The content of the vehicle information provided by the display interface is described in detail in the following paragraphs.

In an embodiment of the disclosure, in addition to the processor 110 deciding to execute a lane change decision to control the vehicle, for the safety of the vehicle itself and to prevent drivers of other vehicles from misunderstanding that the vehicle intends to change lanes, the processor 110 may place the driving direction of the vehicle in the center of the lane using a lane centering system. In addition, the processor 110 may also manage the driving decisions of the vehicle according to the adaptive cruise control system. The aforementioned situations ultimately all cause the processor 110 to execute the decision module and control the vehicle.

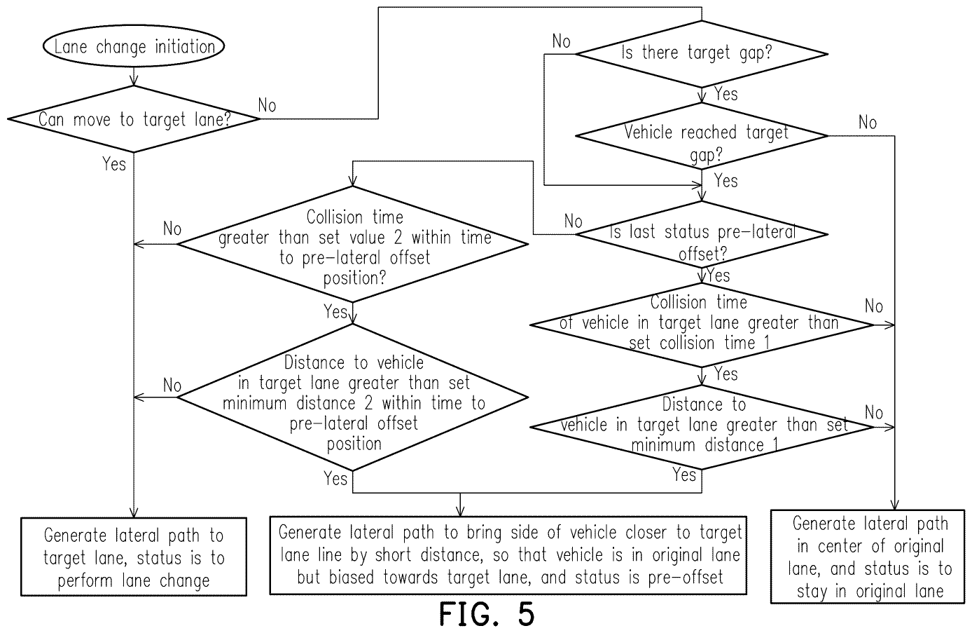

Please refer to FIG. 4. FIG. 4 is a schematic diagram of lane change of the disclosure. Under normal circumstances, the vehicle is driving normally 410 in the center of the lane. When the processor 110 performs pre-lateral offset and pre-offsets 420 the vehicle, it may be seen from FIG. 4 that the vehicle approaches the dotted line in the middle. When the processor 110 determines that the feedback parameter of the vehicle behind the target lane to be changed is greater than a value, for example, when the speed of the rear vehicle is decreased to four-fifths of the original speed, it means that the rear vehicle is willing to yield, and the processor 110 executes the lane change 430 to change the vehicle to the first target lane.

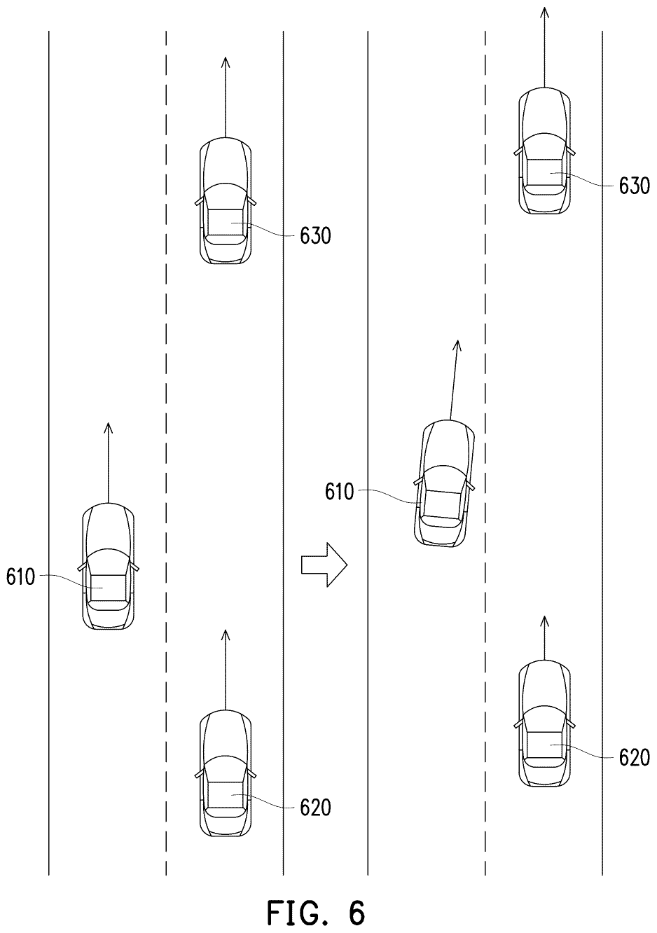

In an embodiment of the disclosure, when the processor 110 executes the decision module and confirms to initiate lane change, the processor 110 may perform the following series of operations. Please refer to FIG. 5. FIG. 5 is a detailed block diagram of pre-lateral offset lane change of the disclosure. The processor 110 may determine whether the vehicle may move to the target lane, that is, determine whether the vehicle may currently change to the first target lane. Since the driver may not be using autonomous driving, even if the current status shows that the vehicle may change to the first lane, the driver may not react and execute the lane change, and then time passes and lane change is ultimately impossible. If the driver uses automatic driving, when the processor 110 determines that the vehicle may be safely moved to the target lane, the processor 110 may directly generate a lateral path and move the vehicle to the target lane, and the status at this time is lane change without performing pre-lateral offset.

Please continue to refer to FIG. 5. When the processor 110 determines that the vehicle may not move to the target lane, the processor 110 may determine whether there is a target gap in the first target lane suitable for vehicle changing. When the processor 110 determines that there is a target gap in the target lane suitable for the vehicle to change lanes, the processor 110 further determines whether the vehicle is in a negative driving lane in the second direction of the target gap in the first target lane. If the vehicle is not in the target gap, the processor 110 generates a lateral path in the center of the original lane and the status is to remain in the original driving lane. That is, if the vehicle has not moved to the target gap, the vehicle may remain in the center of the lane in which the vehicle is traveling to avoid other vehicles from misinterpreting the driving intention of the vehicle. When the processor 110 determines that there is no target gap to change lanes, or the processor 110 determines that the vehicle has reached the target gap, the processor 110 may determine whether the current status of the vehicle is pre-lateral offset.

Continuing from the previous paragraph, when the current status of the vehicle is not pre-lateral offset, the processor 110 determines whether the collision time from the vehicle to the pre-laterally offset position is greater than a set value (first time threshold), and when the collision time is greater than the set value, the processor 110 determines that the distance to the vehicle in the target lane within the time to the pre-lateral offset position is greater than a set minimum distance (first distance threshold). That is, the current vehicle is not in a pre-offset status, so the vehicle is traveling in the center of the current lane (the first area). The time and the distance needed for the vehicle to change to the first target lane are longer than when the vehicle is in the pre-laterally offset position (close to/adjacent to the first lane). Also, since the vehicle may collide with the first neighboring vehicle in the first target lane when changing lanes, the processor 110 determines that the collision time needs to be greater than a first time threshold (e.g., 3 seconds), and the processor 110 determines that the distance between the two vehicles needs to be greater than a first distance threshold (e.g., 3 meters), and then the processor 110 will make the vehicle generate a lateral path so that the side of the vehicle is close to the target lane by a short distance (close to/adjacent to the first lane), and the vehicle is kept in the original driving lane but offset toward the target lane. At this time, the vehicle is in a status of pre-(lateral) offset.

When the processor 110 determines that the collision time is less than the first time threshold or the distance between the two vehicles is less than the first distance threshold, the processor 110 generates a lateral path so that the vehicle travels in the target lane, and the status is to execute lane change. At this point, the processor 110 may look for the next opportunity to perform lane change.

Please continue to refer to FIG. 5, when the current status of the vehicle is pre-lateral offset, the processor 110 determines whether the collision time of the vehicle in the target lane is greater than the preset collision time (second time threshold), and when the collision time is greater than the second time threshold, the processor 110 determines whether the distance to the vehicle in the target lane is greater than a set minimum distance (second distance threshold). That is, the current vehicle is in a pre-offset status, so the vehicle is driving in the current lane close to the lane to be changed (the second area), and the time and the distance needed for the vehicle to change to the first target lane are shorter. However, since a collision may still occur with the first neighboring vehicle in the first target lane when changing lanes, the processor 110 needs to determine that the collision time needs to be greater than a second time threshold (e.g., 1 second), and the processor 110 determines that the distance between the two vehicles needs to be greater than a second distance threshold (e.g., 1 meter), and then the processor 110 continues to generate a lateral path so that the side of the vehicle approaches the target lane by a short distance (close to/adjacent to the first lane), and the vehicle is kept in the original lane but offset toward the target lane. At this time, the vehicle is in a status of pre-(lateral) offset.

When the processor 110 determines that the collision time is less than the second time threshold or the distance between the two vehicles is less than the second distance threshold, the processor 110 generates a lateral path in the center of the original lane, and the status is to remain in the original lane. At this point, the processor 110 may still look for the next opportunity to perform lane change.

Please continue to refer to FIG. 5. When the vehicle is in the aforementioned pre-lateral offset status, and the feedback parameter of the first neighboring vehicle in the first target lane is greater than the first lane change threshold, the vehicle may change to the first lane gap.

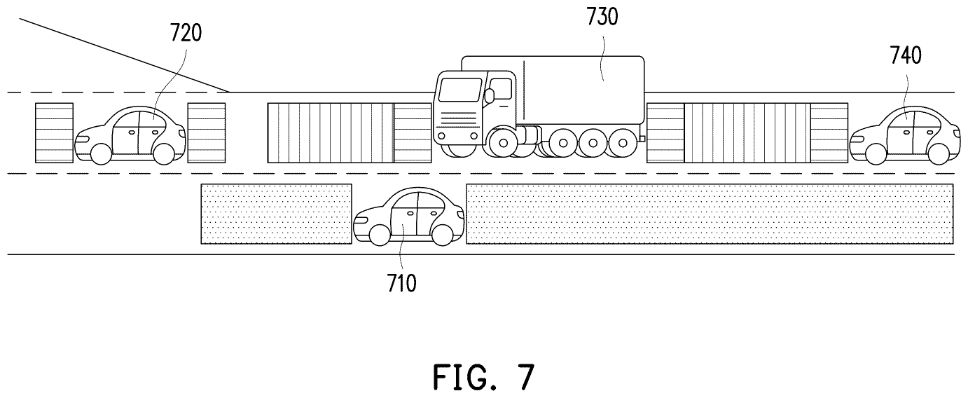

Please refer to FIG. 6. FIG. 6 is a schematic diagram of pre-lateral offset lane change of the disclosure. When a vehicle 610 is traveling in the driving lane, the vehicle 610 wants to change to the first target lane where a vehicle 620 and a vehicle 630 are traveling. At this time, the vehicle 610 may turn slightly in the driving lane so that the vehicle 610 is driven in the driving lane but close to the first target lane and the boundary line of the driving lane. At this time, the vehicle 620 receives the lane-change intention of the vehicle 610 and is willing to let the vehicle 610 change lanes. The vehicle 620 may reduce the speed thereof to increase the distance between the vehicle 620 and the vehicle 630, so that the vehicle 610 may change to the first target lane more safely.

In an embodiment of the disclosure, the gap distance of the first lane may include a safe and feasible range. When the vehicle is driving in the driving lane, the vehicle in the first target lane to which the vehicle is to change may be in the following three situations: there is a vehicle in front of the first lane gap and there is no vehicle behind the first lane gap, there is no vehicle in front of the first lane gap and there is a vehicle behind the first lane gap, and there are vehicles both in front of and behind the first lane gap. The following are explanations of the three situations.

When there is a vehicle in front of the first lane gap and there is no vehicle behind the first lane gap, the first safety distance of the front boundary (first boundary) of the safe and feasible range relative to the rear of the front vehicle is the sum of the following: the first time interval is multiplied by the maximum of the vehicle speed and the first safety distance threshold, the first preset distance, and half of the vehicle body length.

When there is no vehicle in front of the first lane gap and there is a vehicle behind the first lane gap, the second safety distance of the rear boundary (second boundary) of the safe and feasible range relative to the front of the rear vehicle is the sum of the following: the second time interval is multiplied by the maximum of the vehicle speed and the first safety distance threshold, the second preset distance, and half of the vehicle body length.

When there are vehicles both in front and behind the first lane gap, the first safety distance of the front boundary of the safe and feasible range relative to the rear of the front vehicle is the sum of the following: the first time interval is multiplied by the maximum of the vehicle speed and the first safety distance threshold, the first preset distance, and half of the vehicle body length. Moreover, the second safety distance of the rear boundary of the safe and feasible range relative to the front of the rear vehicle is the sum of the following: the second time interval is multiplied by the maximum of the vehicle speed and the first safety distance threshold, the second preset distance, and half of the vehicle body length.

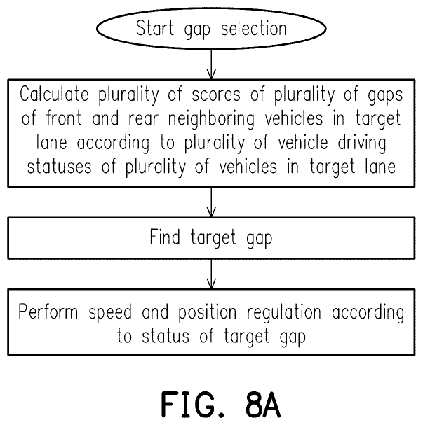

The above safe and feasible range is further described in detail below via FIG. 7. FIG. 7 is a schematic diagram of a dynamic select lane change gap of the disclosure. In FIG. 7, the horizontal line area in the box is the safety margin, the straight line area in the box is the safe and feasible range, and the dotted area in the box is the front and rear range of the vehicle that wants to change lanes in the lane the vehicle is traveling in. As shown in FIG. 7, first, a vehicle 710 wants to change to the target lane where a vehicle 720, a vehicle 730, and a vehicle 740 are located, and the vehicle 710 needs to leave the lane at the interchange indicated by the oblique lines above the vehicle 720 in FIG. 7. Therefore, there is a final lane change position in front of the vehicle 710, and this position may be a position perpendicular to the driving direction where the lane to be changed is connected to the interchange. In other embodiments, when the vehicle needs to turn right and needs to change from the inner lane to the outer lane, this position may also be a position three times the length of the vehicle to be changed from the traffic light. The implementer of the disclosure may define the position of the last lane change according to actual applications.

Please continue to refer to FIG. 7. The right side of the horizontal line area in the right box of the vehicle 720 is the rear safety margin of the vehicle 720. The position of the rear safety margin may be expressed by the following equation (1):

$$Position of rear safety = P 1 - max ( t * v , L 1 ) - P 2 - L 2 \qquad ( 1 )$$

In equation (1), P1 is the center position of the vehicle 720, max represents the maximum value, t is the time interval, v is the speed of the vehicle 720, L1 is the minimum safety distance, P2 is the position uncertainty, and L2 is half the body length of the vehicle 710.

The time interval is related to the tonnage of the vehicle 720. The larger the tonnage of the vehicle 720, the larger the time interval. Relatively speaking, when the tonnage of the vehicle 720 is smaller, the time interval is smaller. The minimum safety distance shown by L1 is the minimum safety distance needed for the vehicle 720 to react when encountering a situation. The position uncertainty of P2 is due to the uncertainty of the position of the vehicle at a future time point generated by the processor 110 when predicting the position of the vehicle for a period of time in the future. Since the processor 110 may predict the future position of the vehicle according to the current driving condition of the vehicle and the driving conditions of the neighboring vehicles around the vehicle, if the driving route of the vehicle or the driving conditions of the neighboring vehicles are not as predicted by the processor 110, there will be an error between the actual position of the vehicle and the predicted position of the vehicle predicted by the processor 110 at a future time. This error is the position uncertainty. Therefore, by deducting this error, the position of the safety margin may be determined more accurately. It should be understood that when the processor 110 predicts the future position of the vehicle, the longer the future time is from the current time, the greater the possibility that the predicted future position is inaccurate, thereby resulting in greater position uncertainty.

Please continue to refer to FIG. 7. The left side of the horizontal line area of the left box of the neighboring vehicle 730 is the front safety margin of the vehicle 730. The position of the front safety margin may be expressed by the following equation (2):

$$Position of front safety = P 3 - max ( t * v , L 3 ) - P 4 - L 4 \qquad ( 2 )$$

In equation (2), P3 is the center position of the vehicle 730, max represents the maximum value, t is the time interval, v is the speed of the vehicle 730, L3 is the minimum safety distance, P4 is the position uncertainty, and L4 is half the body length of the vehicle 710.

The time interval is related to the tonnage of the vehicle 730. The larger the tonnage of the vehicle 730, the larger the time interval. Relatively speaking, when the tonnage of the vehicle 730 is smaller, the time interval is smaller. The minimum safety distance shown by L3 is the minimum safety distance needed for the vehicle 730 to react when encountering a situation. The position uncertainty of P4 is similar to the description of P2 above and is not repeated here.

Please continue to refer to FIG. 7. The boxed straight line area between the vehicle 720 and the vehicle 730 is a safe and feasible range formed by the front safety margin and the rear safety margin. In some embodiments, the processor 110 further adjusts the front boundary of the safe and feasible range by taking into account the last lane change position of the vehicle 710.

Continuing to refer to FIG. 7, the first in the plurality of first lane gaps is formed by the right side of the vehicle 720 and the left side of the vehicle 730. The second in the plurality of first lane gaps is formed by the right side of the vehicle 730 and the left side of the vehicle 740. In an embodiment of the disclosure, the processor 110 may determine to select the first or second first lane gap for lane change according to the current road conditions and the driving conditions of the vehicle 710. For example, although the processor 110 initially selects the first first lane for the vehicle 710 to change, the vehicle 730 may not be willing to yield and does not reduce the speed thereof. After the vehicle 710 has traveled a certain distance in the lateral offset position and reached the accumulated safe and feasible range, or the vehicle 710 has traveled in the lateral offset position for a safe and feasible duration, the processor 110 may instruct the vehicle 710 to abandon the lane change from the first first lane gap, and the processor 110 slows down the speed of the vehicle 710 to enter the range of the second second first lane gap to prepare for lane change.

In an embodiment of the disclosure, the plurality of first lane gaps may be scored to provide a reference for the driver to select the first lane gap when changing lanes. The higher the score, the higher the safety and feasibility for changing lanes. The score may be calculated using the following equation (3):

$$Score ( gap\_i ) = {C}_{1} {\sum }_{t = 0}^{t = {t}_{max}} {R}_{available \_ safe} ( t ) + {C}_{2} ( {t}_{max} - {t}_{b e g i n} ) + {C}_{3} {t}_{d uration} \qquad ( 3 )$$

In the equation, C₁, C₂, and C₃ are constants, R_{available_safe}(t) is the safe and feasible range at time t, tₘₐₓ is the maximum setting time, t_{begin} is the earliest time when the safe and feasible range just begins to appear in the target lane, and t_{duration} is the duration of the safe and feasible range in the target lane.

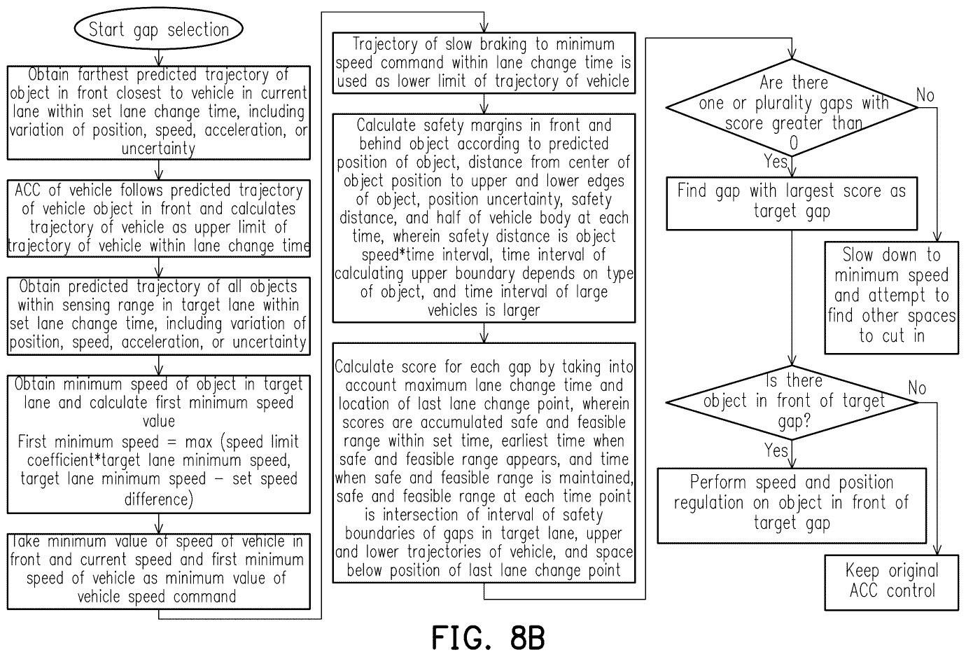

Please refer to FIG. 8A. FIG. 8A is a block diagram of dynamic select lane change gap of the disclosure. FIG. 8 shows a block flow diagram for selecting a gap in a target lane and changing. In FIG. 8, first the vehicle wants to change lanes, so the selection of a lane gap begins. At this time, the processor 110 may calculate a plurality of scores of a plurality of gaps between front and rear neighboring vehicles in the target lane according to the driving statuses of a plurality of vehicles in the target lane. That is, the score of each lane gap is calculated as described in equation (3) above. At this time, the processor 110 may select a target gap according to the score of each lane gap. For example, the processor 110 may select the lane gap with the highest score as the target gap for lane change, or the processor 110 may select the lane gap with a score greater than a safety threshold (e.g., greater than 5 points) and closest to the vehicle as the target gap for lane change. Lastly, the processor 110 may adjust the speed and the position of the vehicle according to the status of the target gap to facilitate subsequent lane change.

Please refer to FIG. 8B. FIG. 8B is a detailed block diagram of a dynamic select lane change gap of the disclosure. In an embodiment of the disclosure, first, the processor 110 may select a first lane gap. The processor 110 may obtain the farthest predicted trajectory of the object closest to the front of the vehicle in the current lane within the set lane change time. The farthest predicted trajectory may consist of the position, velocity, acceleration, or uncertainty variance of the vehicle. Then, the processor 110 may calculate the trajectory of the vehicle as the upper limit of the trajectory of the vehicle within the time of lane change by following the predicted trajectory of the preceding vehicle object. The processor 110 may further obtain the predicted trajectory of all objects within the sensing range in the target lane within the set lane change time. The predicted trajectory may be composed of the position, speed, acceleration, or uncertainty variation of the vehicle. At this time, the processor 110 may obtain the minimum speed of the object in the target lane to calculate the first minimum speed value. The first minimum speed value may be obtained by multiplying the coefficient of the speed limit in the lane by the minimum speed of the target lane, and the maximum of the target lane minimum speed minus the set speed difference.

Continuing from the previous paragraph, please continue to refer to FIG. 8, the processor 110 further selects a minimum value of the vehicle speed command, and the minimum value is the minimum value in the preceding vehicle speed, the current vehicle speed, and the first minimum speed. The lower limit of the trajectory of the vehicle is determined by the trajectory from the set slow braking to the minimum speed command within the lane change time. At this time, the processor 110 calculates the safety margins in front and behind the object according to the predicted position of the object at each time, the distance from the center of the object position to the upper and lower edges of the object, the position uncertainty, the safety distance, and half of the vehicle body. The safety distance is the speed of the object multiplied by the time. In particular, the time interval for calculating the upper boundary is related to the type of object. Vehicles with larger tonnage have larger time intervals. The processor 110 may calculate a score for each gap taking into account the maximum lane change time and the position of the last lane change point. The scores are the accumulated safe and feasible range within the set time, the earliest time when the safe and feasible range appears, and the time when the safe and feasible range is maintained. The safe and feasible range of each time point is the intersection of the spacing of the safety margins of the gaps in the target lane, the upper and lower trajectories of the vehicle, and the space below the position of the last lane change point.

Continuing from the previous paragraph, when the processor 110 determines that there are one or a plurality of gaps with a score greater than 0, the processor 110 may find a gap with the largest score as a target gap for use as lane change. The processor 110 then determines whether there is an object in front of the target gap. If there is an object ahead, the speed of the vehicle is adjusted according to the speed and the position of the object ahead of the target gap to achieve the most suitable status for changing lanes. In other embodiments of the disclosure, if there is no one or plurality of gaps with a score greater than 0, the vehicle may decelerate to a minimum speed and attempt to find another gap to cut into. Moreover, in other embodiments of the disclosure, if the processor 110 selects a gap to switch to, and the processor 110 determines that there is no object in front of the target gap, the original adaptive cruise control may be maintained.

The disclosure further provides an interactive lane change control method that may be executed by the processor 110 of an interactive lane change control system. The various processes and details of the method have been described in detail in the above paragraphs and are not repeated here.

The disclosure also provides a display interface of interactive lane change control that may display a plurality of first lane gaps in a lane to be changed (first lane), and the display interface may also show the willingness of the first neighboring vehicle to give way when the vehicle makes a pre-lateral offset. For example, when the vehicle wants to change lanes, the display interface may display a plurality of first lane gaps (such as the boxed straight lines of FIG. 7) in green to provide the driver with the option of changing lanes. In addition, the display interface may also display the horizontal lines of the boxes in FIG. 7 in red to remind the driver that the red areas are safety margins.

When the vehicle makes a preliminary lateral offset to indicate the intention to change lanes, if the first neighboring vehicle in the first lane (relative to the rear vehicle in the straight direction) reduces the speed thereof, the display interface may display the image of the first neighboring vehicle in green to prompt the driver that the vehicle is willing to give way and change lanes. If the first neighboring vehicle does not slow down, it means that the first neighboring vehicle has no intention to give way, and the display interface may display the image of the first neighboring vehicle in red to remind the driver that the first neighboring vehicle has no intention of yielding to change lanes, so that the driver may slow down and select the next first lane gap to attempt changing.

In an embodiment of the disclosure, the display interface may also display the driving status of the vehicle. For example, if the vehicle intends to change lanes and travels in a pre-laterally offset position (second area), the display interface shows the status of the vehicle as yellow. Or, when the vehicle is traveling on the center line of the lane (the first area), the display interface shows that the status of the vehicle is green.

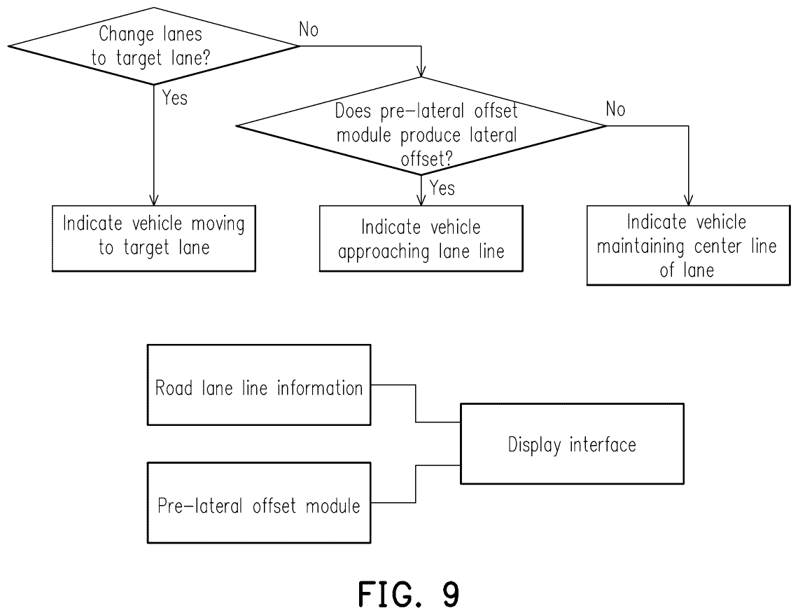

Please refer to FIG. 9. FIG. 9 is a display flowchart of a display interface of interactive lane change control of the disclosure. In FIG. 9, first, the processor 110 may confirm whether the vehicle is to change to the target lane via ACC or the driving control method of the driver. When the processor 110 determines that the vehicle is about to change lanes, and the processor 110 determines that the vehicle is in a status of performing lane change, the display interface may show that the vehicle is about to move to the target lane and display the vehicle in red to remind the driver that the current driving status is changing lanes and the driver needs to pay more attention to driving safety. If the vehicle is not performing a lane change, the processor 110 may determine whether the pre-lateral offset module is being executed and execute the pre-lateral offset. If the processor 110 is executing the pre-lateral offset module, the display interface may show that the vehicle is approaching the lane dividing line, and the display interface may display the vehicle in yellow, indicating that the vehicle is in a status in which attention needs to be paid to whether there is a possibility of collision with neighboring vehicles. If the processor 110 does not execute the pre-lateral offset module, the display interface may show that the vehicle is maintained at the center line of the lane and display the vehicle in green, indicating that the vehicle is in a safe status.

As may be seen from the above, the processor 110 may adjust the display color of the vehicle on the display interface via the information of the vehicle relative to the road lane line and whether the pre-lateral offset module is being executed in order to remind the driver the driving status of the vehicle and relative safety.

Based on the above, in the disclosure, via the interactive lane change control system and method, by pre-laterally offsetting the vehicle, the driver may interact with the neighboring vehicle when changing lanes, thereby obtaining the willingness of the neighboring vehicle to give way, and may change lanes safely when actually changing lanes. In addition, via the display interface, the road conditions and the status of each vehicle may be presented to the driver in a visual manner, allowing the driver to better control the driving status thereof and increase driving safety.

What is claimed is:

1. An interactive lane change control system, comprising:
a storage storing a plurality of modules; and
a processor coupled to the storage and configured to:
execute a dynamic select lane change gap module in the modules to select a first lane gap in a first target lane; and
determine a first path of a vehicle according to a feedback parameter of a first neighboring vehicle.

2. The interactive lane change control system of claim 1, wherein the processor is further configured to:
change the vehicle to the first lane gap in response to the feedback parameter of the first neighboring vehicle being greater than a first lane change threshold;
change the vehicle back to a center line of a driving lane in which the vehicle is traveling in response to the feedback parameter of the first neighboring vehicle being not greater than the first lane change threshold; and
execute a pre-lateral offset exploratory interaction module in the modules to pre-laterally offset the vehicle and test the first neighboring vehicle in the first target lane to obtain the feedback parameter.

3. The interactive lane change control system of claim 2, wherein the processor is further configured to:
determine whether the vehicle is in a first area or a second area of the driving lane.

4. The interactive lane change control system of claim 3, wherein the processor is further configured to:
in response to the vehicle being located in the first area, determine that a first distance between the vehicle and the first neighboring vehicle in the first target lane is greater than a first distance threshold, or determine that a first collision time between the vehicle and the first neighboring vehicle in the first target lane is greater than a first time threshold, and change the vehicle to the first lane gap.

5. The interactive lane change control system of claim 3, wherein the processor is further configured to:
in response to the vehicle being located in the second area, determine that a second distance between the vehicle and the first neighboring vehicle in the first target lane is greater than a second distance threshold, or determine that a second collision time between the vehicle and the first neighboring vehicle in the first target lane is greater than a second time threshold, and change the vehicle to the first lane gap.

6. The interactive lane change control system of claim 1, wherein the first lane gap comprises a safe and feasible range.

7. The interactive lane change control system of claim 6, wherein the first neighboring vehicle is behind the vehicle in a first direction, and a second safety distance of a second boundary of the safe and feasible range relative to a front of the first neighboring vehicle is a sum of the following: a second time interval multiplied by a maximum of a speed of the vehicle and a first safety distance threshold, a second preset distance, and half of a body length of the vehicle.

8. The interactive lane change control system of claim 7, wherein there is also a second neighboring vehicle in the first direction, the second neighboring vehicle is in front of the vehicle in the first direction, and a first safety distance of a first boundary of the safe and feasible range relative to a rear of the second neighboring vehicle is a sum of the following: a first time interval multiplied by a maximum of the speed of the vehicle and a first safety distance threshold, a first preset distance, and half of the body length of the vehicle.

9. The interactive lane change control system of claim 6, wherein a second neighboring vehicle is in front of the vehicle in a first direction, and a first safety distance of a first boundary of the safe and feasible range relative to a rear of the second neighboring vehicle is a sum of the following: a first time interval multiplied by a maximum of a speed of the vehicle and a first safety distance threshold, a first preset distance, and half of a body length of the vehicle.

10. An interactive lane change control method, comprising:
executing a dynamic select lane change gap module in a plurality of modules to select a first lane gap in a first target lane; and
determining a first path of a vehicle according to a feedback parameter of a first neighboring vehicle.

11. The interactive lane change control method of claim 10, further comprising:
changing the vehicle to the first lane gap in response to the feedback parameter of the first neighboring vehicle being greater than a first lane change threshold;
changing the vehicle back to a center line of a driving lane in which the vehicle is traveling in response to the feedback parameter of the first neighboring vehicle being not greater than the first lane change threshold; and
executing a pre-lateral offset exploratory interaction module in the modules to pre-laterally offset the vehicle and test the first neighboring vehicle in the first target lane to obtain the feedback parameter.

12. The interactive lane change control method of claim 11, further comprising:
determining whether the vehicle is in a first area or a second area of the driving lane.

13. The interactive lane change control method of claim 12, further comprising:
determining that a first distance between the vehicle and the first neighboring vehicle in the first target lane is greater than a first distance threshold, or determining that a first collision time between the vehicle and the first neighboring vehicle in the first target lane is greater than a first time threshold in response to the vehicle being located in the first area, and changing the vehicle to the first lane gap.

14. The interactive lane change control method of claim 12, further comprising:
determining that a second distance between the vehicle and the first neighboring vehicle in the first target lane is greater than a second distance threshold, or determining that a second collision time between the vehicle and the first neighboring vehicle in the first target lane is greater than a second time threshold in response to the vehicle being located in the second area, and changing the vehicle to the first lane gap.

15. The interactive lane change control method of claim 10, wherein the first lane gap comprises a safe and feasible range.

16. The interactive lane change control method of claim 15, wherein the first neighboring vehicle is behind the vehicle in a first direction, and a second safety distance of a second boundary of the safe and feasible range relative to a front of the first neighboring vehicle is a sum of the following: a second time interval multiplied by a maximum of a speed of the vehicle and a first safety distance threshold, a second preset distance, and half of a body length of the vehicle.

17. The interactive lane change control method of claim 16, wherein there is also a second neighboring vehicle in the first direction, the second neighboring vehicle is in front of the vehicle in the first direction, and a first safety distance of a first boundary of the safe and feasible range relative to a rear of the second neighboring vehicle is a sum of the following: a first time interval multiplied by a maximum of the speed of the vehicle and the first safety distance threshold, a first preset distance, and half of the body length of the vehicle.

18. The interactive lane change control method of claim 15, wherein a second neighboring vehicle is in front of the vehicle in a first direction, and a first safety distance of a first boundary of the safe and feasible range relative to a rear of the second neighboring vehicle is a sum of the following: a first time interval multiplied by a maximum of a speed of the vehicle and a first safety distance threshold, a first preset distance, and half of a body length of the vehicle.

19. A display interface of an interactive lane change control,
displaying a plurality of first lane gaps in a first target lane; and
displaying each feedback parameter of each first neighboring vehicle in the first lane gaps.

20. The display interface of the interactive lane change control of claim 19, further comprising:
indicating a pre-lateral offset status of a vehicle; or
indicating a status of the vehicle changing back to a lane center line.
